(19) United States
(12) Patent Application Publication
(10) Pub. No.: US 2023/0110197 A1
(43) Pub. Date: Apr. 13, 2023

(54) SOLID STATE ELECTROLYTE, PREPARATION METHOD THEREOF, AND ALL SOLID STATE BATTERY

(71) Applicant: Southern University of Science and Technology, Shenzhen, Guangdong (CN)

(72) Inventors: Juncao BIAN, Shenzhen, Guangdong (CN); Zhouguang LU, Shenzhen, Guangdong (CN); Yusheng ZHAO, Shenzhen, Guangdong (CN)

(73) Assignee: Southern University of Science and Technology, Shenzhen, Guangdong (CN)

(21) Appl. No.: 17/605,627

(22) PCT Filed: Jun. 15, 2021
(86) PCT No.: PCT/CN2021/100174

§ 371 Date: Oct. 22, 2021

(30) Foreign Application Priority Data
Dec. 30, 2020 (CN) 202011628762.8

(51) Int. Cl. H01M 10/056; H01M 10/052

(52) U.S. Cl. CPC H01M 10/056; H01M 10/052

(57) ABSTRACT

The present application provides a solid state electrolyte, a preparation method thereof, and an all solid state battery. Multi-element co-doping of lithium-rich, sodium-rich, potassium-rich anti-perovskite electrolytes on lithium sites or sodium sites or potassium sites, oxygen sites and halogen sites effectively improves the ionic conductivity of the anti-perovskite solid state electrolyte.

### CROSS-REFERENCE TO RELATED APPLICATIONS

This application is the U.S. national phase of PCT Application No. PCT/CN2021/100174 filed on Jun. 15, 2021 which claims the priority of the Chinese patent application with application NO. 202011628762.8 filed at the China National Intellectual Property Administration on Dec. 30, 2020, the entire content of which is incorporated into the present application by reference.

### BACKGROUND

### Technical Field

The present application relates to the technical field of all solid state batteries, in particular, to a composite solid state electrolyte slurry, a preparation method thereof and an all solid state battery.

DESCRIPTION OF RELATED ART All solid state lithium (Li) batteries use solid state electrolyte (SSE) to replace traditional electrolyte, which greatly reduces the risk of battery combustion and explosion, has good safety, and great potential to replace traditional commercial Li-ion batteries. At present, SSE is mainly divided into polymer SSE (such as polyethylene oxide (PEO), PVDF-HFP, etc.) and inorganic SSE (such as Li lanthanum zirconium oxide Li₇La₃Zr₂O₁₂, LLZO, Li titanium aluminum phosphate, Li_{1.4}Al_{0.4}Ti_{1.6}(PO₄)₃) and sulfide Li₇P₃S₁₁, etc.), but the above electrolyte materials face problems such as poor mechanical strength, difficult processing and forming, poor stability, high cost, and difficulty in large-scale production.

Li-rich anti-perovskite (LiRAP) SSE has high Li ion conductivity (up to 10⁻³ S cm⁻¹), wide electrochemical stability window, low preparation temperature, low cost, and easy to large-scale production, and broad prospects for commercialization.

However, LiRAP with high Li ion conductivity is often prepared by a vacuum method, resulting in high material preparation costs and complicated processes. The conductivity of LiRAP prepared under normal pressure is one order of magnitude (10⁻⁴ S cm⁻¹) lower than that of LiRAP prepared by vacuum method.

Therefore, the existing art needs to be further improved.

### SUMMARY

The present application provides a SSE, a preparation method thereof, and an all solid state battery, which aims to solve the technical problem of low ion conductivity of the SSE in the prior art to a certain extent.

The technical solutions of the present application to solve the above technical problems are as follows: On the first aspect, a SSE has a structure shown in Formula 1 or Formula 2:

M₂₋ₐM′ₐOHX_{b}Z_{c} Formula 1,

M₃₋ₐM′ₐOX_{b}Z_{c} Formula 2,

where M is one selected from the group consisting of Li, sodium, and potassium, and M′ is one or more selected from the group consisting of sodium, potassium, rubidium, cesium, boron, magnesium, calcium, strontium, aluminum, gallium, indium, lanthanum, and yttrium, X is one or more selected from the group consisting of F, N, S, Cl, Br and I, Z is one or more selected from BF₄, BH₄, NH₂, NO₂, NO₃, SO₄, BO₃, B₁₀H₁₀, B₁₂H₁₂, CB₉H₁₀ and CB₁₁H₁₂, a=0−1, b=0−1, c=0−1, and M and M′ are not Li, sodium or potassium at the same time; Formula 1 is the structural Formula under custom, which conforms to a stoichiometric ratio.

On the second aspect, a preparation method of the SSE is provided, the method includes:
mixing MOH, M′ OH, M′ X, MX and MZ phases to obtain a precursor mixture; heating the precursor mixture to obtain the SSE.

On the third aspect, a preparation method of the SSE is provided, the method includes:
mixing M₂O, M′ O, M′ X, MX and MZ phases to obtain a precursor mixture; and heating the precursor mixture to obtain the SSE.

Optionally, in the preparation method of the SSE, the heating the precursor mixture to obtain the SSE includes:

heating the precursor mixture to a predetermined temperature to obtain a solid;

cooling and pulverizing the solid to obtain the SSE powder.

On the fourth aspect, an all solid state battery includes a SSE layer, and the SSE layer includes the above SSE.

Optionally, in the all solid-state battery, the SSE layer further includes a binder and a Li salt.

Optionally, in the all solid-state battery, the predetermined temperature is 200-1000° C.

Optionally, in the all solid-state battery, the binder is one or more selected from the group consisting of a styrene butadiene rubber, a nitrile rubber, a butyl rubber, a hydrogenated nitrile rubber, a natural rubber, an isoprene rubber, a butadiene rubber, a chloroprene rubber, a silicone rubber, a fluorine rubber, a polysulfide rubber, a polyurethane rubber, an epichlorohydrin rubber, an acrylic rubber, and an ethylene propylene rubber.

### Beneficial Effects

The present application provides a SSE, multi-element co-doping of Li-rich, sodium-rich, potassium-rich anti-perovskite electrolytes on Li sites or sodium sites or potassium sites, oxygen sites and halogen sites effectively improves the ionic conductivity of the anti-perovskite SSE.

### BRIEF DESCRIPTION OF THE DRAWINGS

FIG. 1 shows differential scanning calorimetry curves before and after Li₂OHCl doping provided by an embodiment of the present application;

FIG. 2 shows XRD patterns of Li₂OHCl before and after doping provided by an embodiment of the present application;

FIG. 3 shows electrochemical impedance spectrums of Li₂OHCl with different doping concentrations provided by an embodiment of the present application;

FIG. 4 shows linear scan curves of Li₂OHCl before and after doping provided by an embodiment of the present application;

FIG. 5 shows a charge-discharge voltage curve of an all solid state battery assembled based on a composite SSE prepared by Li_{1.95}Na_{0.05}OH_{0.95}F_{0.05}Cl_{0.95}(BF₄)_{0.05} according to an embodiment of the present application;

FIG. 6 shows the cycle performance of an all solid state battery assembled based on a composite SSE prepared based on Li_{1.95}Na_{0.05}OH_{0.95}F_{0.05}Cl_{0.95}(BF₄)_{0.05} provided by an embodiment of the present application.

### DETAILED DESCRIPTION

In order to facilitate the understanding of the present application, the present application will be described more fully below with reference to the relevant drawings. The preferred embodiments of the present application are shown in the drawings. However, the present application can be implemented in many different forms and is not limited to the embodiments described herein. On the contrary, the purpose of providing these embodiments is to make the disclosure of the present application more thorough and comprehensive.

Unless otherwise defined, all technical and scientific terms used herein have the same meaning as commonly understood by those skilled in the technical field of the present application. The terminology used in the specification of the present application herein is only for the purpose of describing specific embodiments, and is not intended to limit the present application.

Li-ion batteries have more and more widespread applications in consumer electronics and electric vehicles. Traditional Li-ion batteries use electrolytes containing flammable organic solvents, and are prone to fire and explosion accidents in extreme situations such as internal short-circuits in the batteries, which poses huge safety risks. All solid state Li batteries use SSE to replace traditional liquid electrolyte, which greatly reduces the risk of battery combustion and explosion, having good safety, and great potential to replace traditional commercial Li-ion batteries. At present, SSE (SSE) is mainly divided into polymer SSE (such as polyethylene oxide PEO, PVDF-HFP, etc.) and inorganic SSE (such as Li lanthanum zirconium oxide Li₇La₃Zr₂O₁₂, LLZO, Li titanium aluminum phosphate Li_{1.4}Al_{0.4}Ti_{1.6}(PO₄)₃) and sulfide e.g. Li₇P₃S₁₁, etc.), but the above electrolyte materials face problems such as poor mechanical strength, difficult processing and forming, poor stability, high cost, and difficulty in large scale production.

Li-rich antiperovskite (LiRAP) SSE has high Li ion conductivity (up to 10⁻³ S cm⁻¹), wide electrochemical stability window, low preparation temperature, low cost, easy to large-scale production, and broad prospects for commercialization. However, LiRAP with high Li ion conductivity is often prepared by a vacuum method, resulting in high material preparation costs and complicated processes. However, the conductivity of LiRAP prepared under normal pressure is one order of magnitude (10⁻⁴ S cm⁻¹) lower than that of LiRAP prepared by vacuum method. Therefore, how to improve the Li ion conductivity of LiRAP SSE prepared under normal pressure is an urgent problem to be solved.

Based on this, the present application provides a solution that can solve the above technical problems, the details of which will be described in subsequent embodiments.

Embodiments of the present application provide a SSE having the structure represented by Formula 1:

M₂₋ₐM′ₐOHX_{b}Z_{c} Formula 1,

M is one selected from the group consisting of Li, sodium, and potassium, and M′ is one or more selected from the group consisting of sodium, potassium, rubidium, cesium, boron, magnesium, calcium, strontium, aluminum, gallium, indium, lanthanum, and yttrium, X is one or more selected from the group consisting of F, N, S, Cl, Br, and I, Z is one or more selected from BF₄, BH₄, NH₂, NO₂, NO₃, SO₄, BO₃, B₁₀H₁₀, B₁₂H₁₂, CB₉H₁₀ and CB₁₁H₁₂, a=0−1, b=0−1, c=0−1, and M and M′ are not Li, sodium or potassium at the same time.

In an embodiment, when M is metallic Li(Li), that is, the SSE is Li-rich anti-perovskite (LiRAP) SSE, and its composition structure can be expressed as Li₂₋ₐM′ₐOHX_{b}Z_{c}, M′ is one or more selected from the group consisting of sodium, potassium, rubidium, cesium, boron, magnesium, calcium, strontium, aluminum, gallium, indium, lanthanum, and yttrium, X is halogen, and Z is one selected from BF₄, BH₄, NH₂, NO₂, NO₃, SO₄, BO₃, B₁₀H₁₀, B₁₂H₁₂, CB₉H₁₀, and CB₁₁H₁₂, a=0−1, b=0−1, and c=0−1. As an example, when M′ is metallic potassium (K), X is chlorine, Z is BF₄, and a, b, and c are all 0.5, the SSE has a structure of Li_{1.5}K_{0.5}OHCl_{0.5}((BF₄)_{0.5}.

It should be noted that the above Formula 1 is a structural Formula under custom, which complies with the stoichiometric ratio. It can be understood that Li is +1 valence, K is +1 valence, OH is −1 valence, Cl is −1 valence, BF₄ is −1 valence, then 1*1+1*1=2, that is, the positive valence is 2, (−1*1)+(−1*0.5)+(−1*0.5)=−2, that is, the negative valence is −2. It is easy to understand that for Li RAP containing hydroxide (OH—), its structural Formula must meet the stoichiometric ratio of A₂BC, that is, A is +1 valent cation, and B and C are both −1 valent anion, such as Li₂OHCl.

Furthermore, when the chemical valence of M′ is not +1, a corresponding coefficient should be added to satisfy the stoichiometric ratio of the entire material. As an example, M′ are metallic magnesium (Mg) and aluminum (Al), X are chlorine (Cl) and bromine (Br), Z are BF₄ and NH₂, and the SSE after doping has the chemical Formula of ((Li_{1.75}Mg_{0.05}Al_{0.05})(OH_{0.9}F_{0.1})[Cl_{0.5}Br_{0.3}((BF₄)_{0.1}((NH₂)_{0.1}].

In an embodiment, when M is sodium metal (Na), that is, the SSE is sodium-rich anti-perovskite (NaRAP) SSE, and its composition structure can be expressed as Na₂₋ₐM′ₐOHX_{b}Z_{c}, M′ is one selected from the group consisting of potassium, rubidium, cesium, boron, magnesium, calcium, strontium, aluminum, gallium, indium, lanthanum, and yttrium, X is halogen, and Z is one selected from the group consisting of BF₄, BH₄, NH₂, NO₂, NO₃, SO₄, BO₃, B₁₀H₁₀, B₁₂H₁₂, CB₉H₁₀, and CBuH₁₂, a=0−1, b=0−1, and c=0−1. As an example, when M′ is metallic potassium (K), X is bromine, and Z is NH₂, the SSE has a structure of Na_{1.95}K_{0.05}OHCl_{0.95}((NH₂)_{0.05}.

In an embodiment, when M is metallic potassium (K), that is, the SSE is potassium-rich anti-perovskite (KRAP) SSE, and its composition structure can be expressed as K₂₋ₐM′ₐOHX_{b}Z_{c}, M′ is one or more selected from the group consisting of sodium, rubidium, cesium, boron, magnesium, calcium, strontium, aluminum, gallium, indium, lanthanum, and yttrium, X is halogen, and Z is one or more selected from the group consisting of BF₄, BH₄, NH₂, NO₂, NO₃, SO₄, BO₃, B₁₀H₁₀, B₁₂H₁₂, CB₉H₁₀, CB₁₁H₁₂, a=0−1, b=0−1, c=0−1. As an example, M′ is metallic calcium (Ca), X is fluorine, Z is SO₄, and the SSE has a structure of K_{1.5}Ca_{0.25}OHF. It is easy to understand that in this structural Formula, K is +1 valence, Ca is +2 valence, OH is −1 valence, F is −1 valence, then (1*1.5)+(0.25*2)=2, that is, the positive valence is 2, (−1*1)+(−1*1)=−2, that is, the negative valenceis −2.

The embodiment of the present application provides a SSE having a structure represented by Formula 2:

M₃₋ₐM′ₐOX_{b}Z_{c} Formula 2,

where M is one selected from the group consisting of Li, sodium, and potassium, and M′ are two or more selected from the group consisting of sodium, potassium, rubidium, cesium, boron, magnesium, calcium, strontium, aluminum, gallium, indium, lanthanum, and yttrium. X is one selected from the group consisting of F, N, S, Cl, Br, I, Z is one or more selected from the group consisting of BF₄, BH₄, NH₂, NO₂, NO₃, SO₄, BO₃, B₁₀H₁₀, B₁₂H₁₂, CB₉H₁₀, CB₁₁H₁₂, a=0−1, b=0−1, c=0−1, and M and M′ are not sodium or potassium at the same time.

In an embodiment, when M is metallic Li(Li), that is, the SSE is LiRAP SSE, and its composition structure can be expressed as M₃₋ₐM′ₐOX_{b}Z_{c}, where M′ are two or more selected from the group consisting of sodium, potassium, rubidium, cesium, boron, magnesium, calcium, strontium, aluminum, gallium, indium, lanthanum, and yttrium, X is one or more selected from the group consisting of F, N, S, Cl, Br, I, Z is one or more selected from the group consisting of BF₄, BH₄, NH₂, NO₂, NO₃, SO₄, BO₃, B₁₀H₁₀, B₁₂H₁₂, CB₉H₁₀, CB₁₁H₁₂, a=0−1, b=0−1, c=0−1, and M and M′ are not sodium or potassium at the same time. As an example, if a and c are 0, and X is Br, the SSE has the structure of Li₃OBr. It should be noted that the above Formula 2 is a structural Formula under custom, which complies with the stoichiometric ratio. It can be understood that Li is +1 valence, 0 is −2 valence, Br is −1 valence, then 1*3=3, that is, the positive valence is 3, (−2*1)+(−1*1)=−3. That is, the negative valence is −3. It is easy to understand that when a and c are 0, for Li RAP without hydroxide (OH—), its structural Formula must meet the stoichiometric ratio of A₃BC, that is, A is +1 cation, and B is a −2 anion and C are both −1 anions, such as Li₃OBr.

In an embodiment, when M is sodium metal (Na), that is, the SSE is sodium-rich anti-perovskite (NaRAP) SSE, and its composition structure can be expressed as M₃₋ₐM′ₐOX_{b}Z_{c}, where M′ are two or more selected from the group consisting of Li, potassium, rubidium, cesium, boron, magnesium, calcium, strontium, aluminum, gallium, indium, lanthanum, and yttrium, X is one or more selected from the group consisting of F, N, S, Cl, Br, I, Z is one or more selected from the group consisting of BF₄, BH₄, NH₂, NO₂, NO₃, SO₄, BO₃, B₁₀H₁₀, B₁₂H₁₂, CB₉H₁₀, CBuH₁₂, a=0−1, b=0−1, c=0−1, and M and M′ are not sodium or potassium at the same time. As an example, if a and c are 0, and X is Br, the SSE has the structure of Na₃OBr. It should be noted that the above Formula 2 is a structural Formula under custom, which complies with the stoichiometric ratio. That can be understood as Na is +1 valence, 0 is −2 valence, Br is −1 valence, then 1*3=3, that is, the positive valence is 3, (−2*1)+(−1*1)=−3. That is, the negative valence is −3. It is easy to understand that when a and c are 0, for NaRAP without hydroxide (OH—), its structural Formula must meet the stoichiometric ratio of A₃BC, that is, A is a +1 cation and B is a −2 anion, C are −1 anions, such as Na₃OBr.

In an embodiment, when M is metallic potassium (K), that is, the SSE is potassium-rich anti-perovskite (KRAP) SSE, and its composition structure can be expressed as M₃₋ₐM′ₐOX_{b}Z_{c}, where M′ are two or more selected from the group consisting of sodium, Li, rubidium, cesium, boron, magnesium, calcium, strontium, aluminum, gallium, indium, lanthanum, and yttrium, X is one selected from the group consisting of F, N, S, Cl, Br, I, Z is one or more selected from the group consisting of BF₄, BH₄, NH₂, NO₂, NO₃, SO₄, BO₃, B₁₀H₁₀, B₁₂H₁₂, CB₉H₁₀, CB₁₁H₁₂, a=0−1, b=0−1, c=0−1, and M and M′ are not sodium or potassium at the same time. As an example, if a and c are 0, and X is Br, the SSE has the structure of K₃OBr. It should be noted that the above Formula 2 is a structural Formula under custom, which complies with the stoichiometric ratio. It can be understood that K is +1 valence, 0 is −2 valence, Br is −1 valence, then 1*3=3, that is, the positive valence is 3, (−2*1)+(−1*1)=−3. That is, the negative valence is −3. It is easy to understand that when a and c are 0, for K RAP without hydroxide (OH—), its structural Formula must meet the stoichiometric ratio of A₃BC, that is, A is a +1 cation, and B is a −2 anion and C are all −1 valent anions, such as K₃OBr.

In the above embodiment, by introducing ions with a larger atomic radius at the Li site, Na site, or K site, the lattice constant is increased, and the diffusion channel of the ions is increased; high-valent cations with +2 or +3 valence are used instead of +1 valence of Li, Na or K which increases the concentration of Li or Na vacancies in the lattice to achieve the purpose of improving the conductivity of Li ions; using the paddle wheel effect of superionic clusters to reduce the barrier for Li or Na diffusion and reduce the activation energy of ion diffusion, achieving the purpose of improving ion conductivity. At the same time, different doping elements form a synergistic effect to further improve the ionic conductivity of the SSE material.

In an implementation of an embodiment, the SSE is in powder form. In some embodiments, the SSE is irregular particles, and the particle size may be 1 nm-10 nm, 10 nm-20 nm, 20 nm-30 nm, 30 nm-50 nm, 50 nm-70 nm, 70 nm-90 nm, 90 nm-120 nm, 120 nm-200 nm, 200 nm-500 nm, 500 nm-700 nm, 700 nm-1 m, 1 m-5 m, 5 m-10 m, 10 m-20 m, 20 m-40 m, 40 m-60 m, 60 m-80 m, 80 m-100 m, but not limited to this, in other words, the particle size of the SSE can be selected according to actual needs.

Based on the same inventive concept, the embodiments of the present application also provide a method for preparing a SSE, the method including:

S10. Mixing MOH, M′OH, M′X, MX and MZ phases to obtain a precursor mixture.

When M is metallic Li, that is, Li₂₋ₐM′ₐOHX_{b}Z_{c}, powdered LiGH, LiCl, MgOH, or MgCl, LiF, and LiBH₄ can be used as raw materials, and the uniformly mixed raw materials can be placed into the container and mechanically mixed to obtain a mixture.

Further, in step S10, M₂O, M′O, M′X, MX, and MZ phases may also be mixed to obtain a precursor mixture.

In an embodiment, the particle size of the powdered raw materials used can be selected according to needs. For example, the particle size range is 5 m to 8 m, and the particle size of the raw materials is selected within this range, which can facilitate the uniform mixing of the mixture, thereby the composition of the obtained product is also more uniform.

In an embodiment, powdered LiGH, LiCl, MgOH or MgCl, LiF and LiBH₄ are used as raw materials, and the mixing must be carried out in a certain dry environment. The dry environment means that the relative humidity of the environment is less than 30% or the dew point is less than −20 degrees. By controlling the humidity of the environment, it is possible to avoid powder agglomeration during mixing and resultant ununiform mixing.

S20, heating the mixture to obtain the SSE.

The container containing the mixture (the uniformly mixed raw material powder) is transferred to a high-temperature furnace, heated to a certain temperature at a certain heating rate for sintering, and then cooled naturally or rapidly cooled to obtain agglomerates. The agglomerates are crushed and ground to the required particle size to obtain the target product in powder form. It should be noted that the machines and grinding processes used for crushing and grinding are all existing technologies, and the specific operation steps are not repeated here.

In an embodiment, the sintering temperature may be 200° C.−400° C., 400° C.−600° C., 600° C.−800° C., 800° C.−1000° C.

Based on the same inventive concept, the present application also provides an all solid-state battery, which includes: a positive electrode layer, a negative electrode layer, and a SSE layer. The SSE layer was disposed between the positive electrode layer and the negative electrode layer.

In an embodiment, as an example, it includes known positive electrode active materials used in solid-state batteries, Li-containing oxides (Li cobalt oxide (LiCoO₂), Li manganese oxide (LiMnO₂), Li vanadium oxide (LiVO₂), Li chromium oxide (LiCrO₂), Li nickel oxide (LiNiO₂), Li nickel cobalt manganese oxide (NCM523, NCM622, NCM811, etc.), Li nickel cobalt aluminum oxide (LiNiCoAlO₂) and other transition metal oxides or Li iron phosphate (LiFePO₄)). The negative electrode layer includes negative electrode active materials known to be used in solid-state batteries, such as carbon active materials (graphite), nano silicon materials, silicon-carbon composite materials, oxide active materials (transition metal oxides), or metal active materials (Li-containing metal active materials and Li-related alloy materials, indium-containing metal active materials, and tin-containing metal active materials).

In an embodiment, the SSE layer includes a binder and a Li salt. As an example, the binder is one or more selected from the group consisting of styrene butadiene rubber, nitrile rubber, butyl rubber, hydrogenated nitrile rubber, natural rubber, isoprene rubber, butadiene rubber, chloroprene rubber, silicone rubber, fluorine rubber, polysulfide rubber, polyurethane rubber, epichlorohydrin rubber, acrylic rubber, and ethylene propylene rubber.

In an embodiment, the Li salt is one or more selected from the group consisting of Li bis(trifluoromethylsulfonyl)imide, Li bisfluorosulfonimide, aluminum perchlorate, and tetrafluoroboric acid, Li hexafluorophosphate, Li trifluoromethanesulfonate, tetraethylammonium tetrafluoroborate, Li bisoxalate borate, and Li difluorooxalate borate.

In an embodiment, the SSE can be mixed with the binder and the Li salt solution to prepare a composite SSE slurry after grinding, and the resulting slurry was coated on the positive electrode layer. The negative electrode layer is laminated on the coating, and an all solid state battery was obtained after drying.

The SSE, the preparation method thereof, and the all solid state battery provided by the present application will be further explained by specific preparation examples as below.

### Example 1

In an environment with a relative humidity of 25%, LiGH, NaOH, LiF, LiCl, LiBr, and LiNO₃ were added into the container, mixed and stirred to make them evenly mixed (refer to the ratio of Formula 1 a=0.5, b=0, c=0.05), then the container was put into a high-temperature furnace for sintering to obtain aggravated SSE with a structure of Li_{1.5}Na_{0.5}OH_{0.9}F_{0.1}Cl_{0.5}Br_{0.45}((NO₃)_{0.05}, after natural cooling, the SSE was pulverized and grinded to obtain Li_{1.5}Na_{0.5}OH_{0.9}F_{0.1}Cl_{0.5}Br_{0.45}((NO₃)_{0.05} SSE powder with a particle size of 100 nm.

### Example 2

In an environment with a relative humidity of 30%, LiGH, NaF, and LiBH₄ were added into the container, mixed and stirred to make them evenly mixed (refer to the ratio of Formula 1 for a=0.05, b=1, and c=1), the container was put into a high-temperature furnace for sintering to obtain a massive SSE with a structure of Li_{1.95}Na_{0.05}OH_{0.95}F_{0.05}BH₄. After natural cooling, the SSE was pulverized and ground to obtain Li_{1.95}Na_{0.05}OH_{0.95}F_{0.05}BH₄ SSE powder with a particle size of 1 m.

### Example 3

In an environment with an environmental dew point of −25 degrees, LiGH, KOH, MgCl₂, AlCl₃, LiF, LiCl, and LiBF₄ were added into the container, mixed and stirred to make them evenly mixed (refer to ratio of Formula 1, a=0.05, b=0.95, c=0.05), and then the container was put into a high-temperature furnace for sintering to obtain a aggravated SSE with a structure of Li_{1.7}K_{0.05}Mg_{0.05}Al_{0.05}OH_{0.95}F_{0.05}Cl_{0.95}(BF₄)_{0.05}, After being naturally cooled, the SSE was pulverized and ground to obtain Li_{1.7}K_{0.05}Mg_{0.05}Al_{0.05}OH_{0.95}F_{0.05}Cl_{0.95}(BF₄)_{0.05} SSE powder having a particle size of 80 μm.

### Example 4

In an environment with a relative humidity of 30%, Li₂O, LiBr, LiBF₄, and LiBH₄ were added into the container, mixed and stirred to make them evenly mixed (refer to the ratio of Formula 2, a=0, b=1, and c=1), then the container was put into a high-temperature furnace for sintering to obtain aggravated SSE with a structure of Li₂NaOBr_{0.9}(BF₄)_{0.05}(BH₄)_{0.05}. After natural cooling, the SSE was pulverized and ground to obtain Li₂NaOBr_{0.9}(BF₄)_{0.05}(BH₄)_{0.05} SSE powder having a particle size of 1 m.

Performance Testing

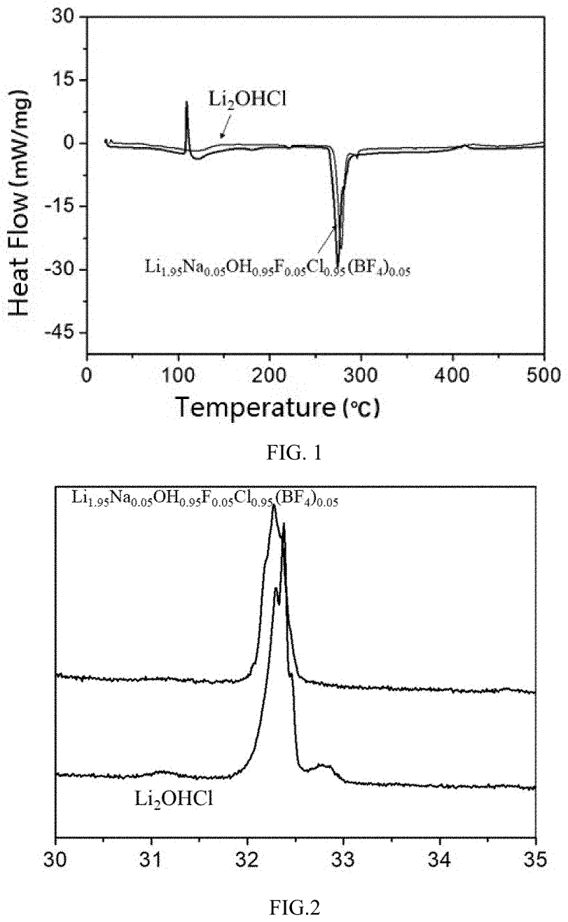

The Li₂OHCl SSE powder prepared in Example 4 was doped with the SSE powder, and the differential scanning calorimetry was used for comparison verification. The differential scanning calorimetry curve is shown in FIG. 1. The differential scanning calorimetry curve shows that the crystal lattice of the doped material changes slightly, and the material has an endothermic peak at about 110° C. The X-ray diffraction pattern is shown in FIG. 2. The XRD data shows that the main diffraction peak position of the doped material is reduced. It shows that the lattice parameter of the material increases, which provides more space for the migration of ions in the material. The ionic conductivity of the prepared anti-perovskite SSE can reach the order of 10⁻⁵ S cm⁻¹ at the highest. The electrochemical impedance of the doped SSE is reduced to one-sixth of that of the intrinsic material.

Using the electrochemical linear scanning method, the test curve is shown in FIG. 4. From the curve, it can be seen that the electrochemical stability window of the Li-rich anti-perovskite SSE prepared by doping can reach 6V.

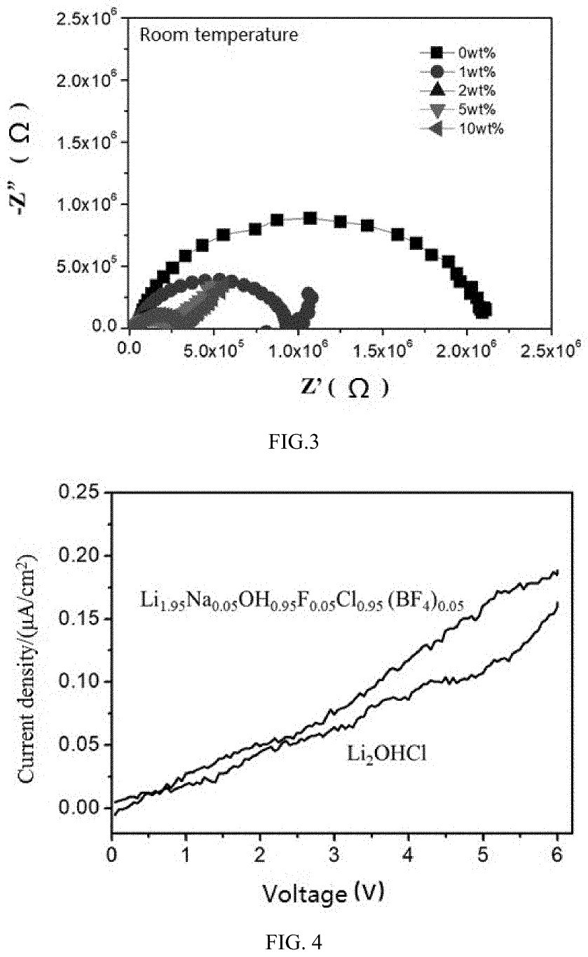

The Li_{1.95}Na_{0.05}OH_{0.95}F_{0.05}Cl_{0.95}(BF₄)_{0.05} SSE powder was used to dope the Li₂OHCl SSE powder. The electrochemical impedance of different doping concentrations is shown in FIG. 3.

### Example 5

Based on the Li_{1.95}Na_{0.05}OH_{0.95}F_{0.05}Cl_{0.95}(BF₄)_{0.05} SSE prepared in Example 4, it was mixed with styrene-butadiene rubber sol (which was obtained by dissolving styrene-butadiene rubber in a non-polar solvent) and Li tetrafluoroborate solution and the mixture was put into a ball mill tank for grinding to obtain a composite SSE slurry, which was coated on the surface of the positive electrode layer (Li cobalt oxide) using a coater to form a composite SSE layer, a negative electrode layer was laminated on the composite SSE layer, and an all solid state battery was obtained after encapsulation.

Performance Testing

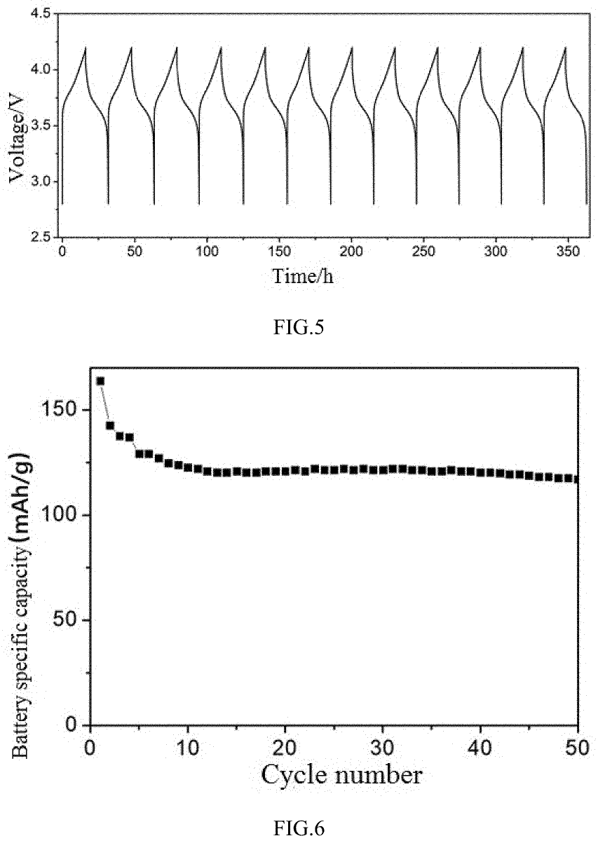

The prepared all solid state battery was subjected to charge-discharge and cycle performance tests. The results are shown in FIGS. 5 and 6. The data show that the charge-discharge voltage curve and cycle performance of the battery have quantitative repeatability.

In conclusion, the present application provides a SSE, a preparation method thereof, and an all solid state battery. By introducing ions with a larger atomic radius at the Li site, Na site, or K site, the lattice constant is increased, and the ions diffusion channels are increased; use +2 or +3 high-valent cations to replace +1 valent Li, Na, or K to increase the concentration of Li or Na vacancies in the crystal lattice to achieve the purpose of improving the conductivity of Li ions; the use of the paddle wheel effect of superionic clusters reduces the diffusion barrier of Li or Na and the activation energy of ion diffusion, achieving the purpose of improving ion conductivity. At the same time, different doping elements form a synergistic effect to further improve the ionic conductivity of the SSE material. The method in the present application has the advantages of high Li ion conductivity of material, wide electrochemical window, low cost, high efficiency, and suitability for large-scale production, and provides a new technical solution for preparing low-cost solid-state batteries.

The above are only the preferred embodiments of the present application and are not intended to limit the present application. Any modification, equivalent replacement, improvement made within the spirit and principle of the present application shall be within the protection scope of the present application.

1. A solid state electrolyte, having a structure shown in Formula 1 or Formula 2:
M₂₋ₐM′ₐOHX_{b}Z_{c} Formula 1,
M₃₋ₐM′ₐOX_{b}Z_{c} Formula 2,
M is one selected from the group consisting of lithium, sodium, and potassium, and M′ is one or more selected from the group consisting of sodium, potassium, rubidium, cesium, boron, magnesium, calcium, strontium, aluminum, gallium, indium, lanthanum, and yttrium, X is one or more selected from the group consisting of F, N, S, Cl, Br, and I, Z is one or more selected from BF₄, BH₄, NH₂, NO₂, NO₃, SO₄, BO₃, B₁₀H₁₀, B₁₂H₁₂, CB₉H₁₀ and CB₁₁H₁₂, a=0−1, b=0−1, c=0−1, and M and M′ are not lithium, sodium or potassium at the same time; Formula 1 is a structural Formula under custom, which conforms to a stoichiometric ratio.

2. The solid state electrolyte according to claim 1, the solid state electrolyte is in a powder form.

3. The solid state electrolyte according to claim 2, the solid state electrolyte has a particle size of 1 nm −100 km.

4. A preparation method of the solid state electrolyte according to claim 1, when the solid state electrolyte has the structure shown in Formula 1, the method comprises:
mixing MOH, M′ OH, M′ X, MX and MZ phases to obtain a precursor mixture; and
heating the precursor mixture to obtain the solid state electrolyte; and
when the solid state electrolyte has the structure shown in Formula 2, the method comprises:
mixing M₂O, M′O, M′ X, MX and MZ phases to obtain a precursor mixture; and
heating the precursor mixture to obtain the solid state electrolyte.

5. (canceled)

6. The preparation method of solid state electrolyte according to claim 4,
mixing the MOH, M′OH, M′X, MX and MZ phases or the M₂O, M′O, M′X, MX and MZ phases in a dry environment.

7. The preparation method of the solid state electrolyte according to claim 4, the heating the precursor mixture to obtain the solid state electrolyte comprises:
heating the precursor mixture to a predetermined temperature to obtain a solid; and
cooling and pulverizing the solid to obtain a solid state electrolyte powder.

8. The preparation method of the solid state electrolyte according to claim 6, the dry environment is that an environmental relative humidity is less than 30% or a dew point temperature is less than −20° C.

9. The preparation method of the solid state electrolyte according to claim 7, the predetermined temperature is 200−1000° C.

10. An all solid state battery, the all solid state battery comprises a solid state electrolyte layer, and the solid state electrolyte layer comprises the solid state electrolyte according to claim 1.

11. The all solid state battery according to claim 10, the solid state electrolyte layer further comprises a binder and a lithium salt.

12. The all solid battery according to claim 11, the binder is one or more selected from the group consisting of a styrene butadiene rubber, a nitrile rubber, a butyl rubber, a hydrogenated nitrile rubber, a natural rubber, an isoprene rubber, a butadiene rubber, a chloroprene rubber, a silicone rubber, a fluorine rubber, a polysulfide rubber, a polyurethane rubber, an epichlorohydrin rubber, an acrylic rubber, and an ethylene propylene rubber.

13. The all solid state battery according to claim 11, the lithium salt is one or more selected from the group consisting of lithium bis(trifluoromethylsulfonyl)imide, lithium bisfluorosulfonimide, aluminum perchlorate, and tetrafluoroboric acid, lithium hexafluorophosphate, lithium trifluoromethanesulfonate, tetraethylammonium tetrafluoroborate, lithium bisoxalate borate, and lithium difluorooxalate borate.
